(19) United States
(12) Patent Application Publication
(10) Pub. No.: US 2021/0363677 A1
(43) Pub. Date: Nov. 25, 2021

(54) Plastic woven fabric sewing machine

(71) Applicant: Pao-Chung Chang, Taichung (TW)

(72) Inventor: Pao-Chung Chang, Taichung (TW)

(21) Appl. No.: 17/227,404

(22) Filed: Apr. 12, 2021

(30) Foreign Application Priority Data
May 22, 2020 (TW) 109117011

(51) Int. Cl. D05B 1/08

(52) U.S. Cl. CPC D05B 1/08

(57) ABSTRACT

A plastic woven fabric sewing machine includes a stitching device on a tabletop of a worktable in which two overlapped fabrics are placed on the tabletop to be stitched, a tip of a needle portion of a stitching needle cylinder penetrates through the two fabrics to enter a thread knot shaping recess, a plastic material in a chamber is injected into the thread knot shaping recess from a needle hole, after the injected plastic material is cooled, it forms a thread knot to buckle the two fabrics, the tip of the needle portion is retracted from the two fabrics to generate a short stitching thread section, the tip of the needle portion is displaced on the two fabrics to complete one stitch of the two fabrics, the two fabrics are stitched together through continuous multiple stitches, and the stitches each have the thread knot.

### FIELD OF THE INVENTION

The present invention relates to a fabric sewing machine, and more particularly to a plastic woven fabric sewing machine for two fabrics to be stitched together with continuous multiple stitches each having a thread knot to provide an independent buckle effect so that the stitches do not affect each other to improve the connection of the two fabrics.

### BACKGROUND OF THE INVENTION

For chemical fiber fabrics, a conventional sewing machine generally uses stitching threads of different materials to stitch chemical fiber fabrics. For example, the fabrics are made of PET or nylon, and the stitching threads are made of cotton. When the chemical fiber fabrics are used as waste materials, the stitching threads of different materials are not beneficial for recycling and reusing, which will affect the quality of recycling. Besides, when one of the stitches of the fabrics breaks, the other stitches will be affected to fall off. Sometimes, the endurance of the finished product is reduced to break the product, so the reliability of the conventional chemical fiber fabric sewing machine is low. Accordingly, the inventor of the present invention has devoted himself based on his many years of practical experiences to solve these problems.

### SUMMARY OF THE INVENTION

The primary object of the present invention is to provide a plastic woven fabric sewing machine, comprising at least one stitching device at one end of a tabletop of a low-temperature worktable.

The tabletop of the worktable is provided with at least one thread knot shaping recess.

The stitching device includes a stitching needle cylinder. The stitching needle cylinder has a cylinder body mounted to a support frame that can be reciprocated up and down. One end of the stitching needle cylinder is formed with a needle portion relative to the thread knot shaping recess. The needle portion has a tip that is moved close to and away from the tabletop of the worktable through the cylinder body of the stitching needle cylinder for the tip to be inserted in and out of the thread knot shaping recess. The tip is formed with a needle hole communicating with one end of a chamber inside the cylinder body. Another end of the chamber is provided with a material inlet. The material inlet is configured to receive a pressurized molten plastic material from a material receiving tube.

When in use, two overlapped fabrics are placed on the tabletop of the worktable to be stitched, the tip of the needle portion of the stitching needle cylinder penetrates through the two fabrics to enter the thread knot shaping recess, the plastic material in the chamber is injected into the thread knot shaping recess from the needle hole, after the injected plastic material is cooled, it forms a thread knot to buckle the two fabrics, after that, the tip of the needle portion is retracted from the two fabrics to generate a short stitching thread section, the tip of the needle portion is relatively displaced on the two fabrics to complete one stitch of the two fabrics, the two fabrics are stitched together through continuous multiple stitches, the stitches each have the thread knot to provide an independent buckle effect so that the stitches do not affect each other.

Preferably, the support frame includes a lift platform and a pair of slide seats. The stitching needle cylinder is disposed on the slide seats. The slide seats are moved up and down on the lift platform to control the needle portion to perform the stitching action.

Preferably, the tabletop of the worktable is provided with at least one linear slide rail assembly. The linear slide rail assembly includes a Y-axis linear slide rail and an X-axis linear slide rail. The X-axis linear slide rail is configured to slide on the Y-axis linear slide rail. The X-axis linear slide rail is provided with the stitching device. Through the Y-axis linear slide rail and the X-axis linear slide rail, the stitching device performs Y-axis and X-axis displacement and stitching actions on the tabletop, so that a computer automatically controls the stitching effect of the needle portion on the two fabrics.

Preferably, one end of the tabletop of the worktable is provided with a roller feeding device, and another end of the tabletop of the worktable is provided with a roller receiving unit. The roller receiving device includes a first receiving roller and a second receiving roller. A movable steering roller that is moved up and down in a groove and an immovable steering roller are provided between the first receiving roller and the second receiving roller. A first sensor and a second sensor are provided above and under the movable steering cylinder, respectively. When the first receiving roller continues to roll up the fabrics, the movable steering roller is displaced to the bottom of the groove to trigger the first sensor, such that the first receiving roller stops and the second receiving roller starts to roll up the fabrics. When the second receiving roller continues to roll up the fabrics, the movable steering roller is displaced to the top of the groove to trigger the second sensor, such that the second receiving roller stops and the first receiving roller starts to roll up the fabrics. The roller receiving unit can precisely roll up the fabrics.

Preferably, an interior of the worktable is provided with at least one cooling water channel close to the thread knot shaping recess. After the plastic material in the chamber is injected from the needle hole into the thread knot shaping recess, the cooling water can effectively reduce the temperature of the molten plastic material and accelerate the effect of cooling and solidification.

Preferably, a press member is provided around the needle portion of the stitching needle cylinder, and an elastic member is accommodated between the press member and the end of the stitching needle cylinder. When the needle portion of the stitching needle cylinder is inserted downward toward the two fabrics, the end face of the press member is pressed against the two fabrics to stabilize the stitching actions of the needle portion. Furthermore, the elastic force of the elastic member returns the press member to the initial position, so as to produce a better stitching smoothness.

Preferably, the stitching needle cylinder has a thermostat for maintaining a molten state of the plastic material, thereby avoiding solidification of the plastic material in the stitching process.

Preferably, the material receiving tube is a soft curved tube.

Embodiments of the present invention will now be described, by way of example only, with reference to the accompanying drawings.

### BRIEF DESCRIPTION OF THE DRAWINGS

FIG. 1 is an exploded view of a first embodiment of the present invention;

FIG. 1A is an enlarged view of circle A of FIG. 1;

FIG. 2 is a perspective view of the stitching device of the present invention;

FIG. 2A is an enlarged view of circle A of FIG. 2;

FIG. 2B is a cross-sectional view of the stitching device of the present invention;

FIG. 3 is a perspective view of the first embodiment of the present invention;

FIG. 3A is an enlarged view of circle A of FIG. 3;

FIG. 4 is a perspective view of the first embodiment of the present invention when in use;

FIG. 4A is an enlarged view of circle A of FIG. 4;

FIG. 5 is a front sectional view of the first embodiment of the present invention when in use;

FIG. 6 is a cross-sectional view showing the first operation of the stitching device of the present invention when in use;

FIG. 7 is a cross-sectional view showing the second operation of the stitching device of the present invention when in use;

FIG. 8 is a cross-sectional view showing the third operation of the stitching device of the present invention when in use;

FIG. 9 is a cross-sectional view showing the fourth operation of the stitching device of the present invention when in use;

FIG. 10 is a perspective view of a second embodiment of the present invention;

FIG. 10A is an enlarged view of circle A of FIG. 10;

FIG. 11 is a perspective view of the second embodiment of the present invention when in use;

FIG. 11A is an enlarged view of circle A of FIG. 11;

FIG. 11B is an enlarged view of circle B of FIG. 11; and

FIG. 11C is an enlarged view of circle C of FIG. 11.

### DETAILED DESCRIPTION OF THE PREFERRED EMBODIMENTS

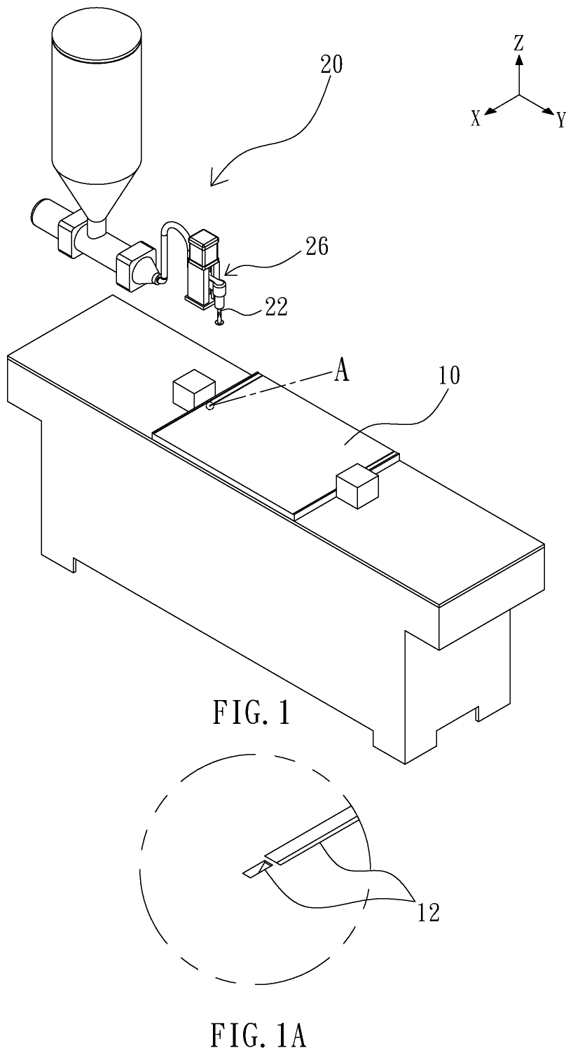

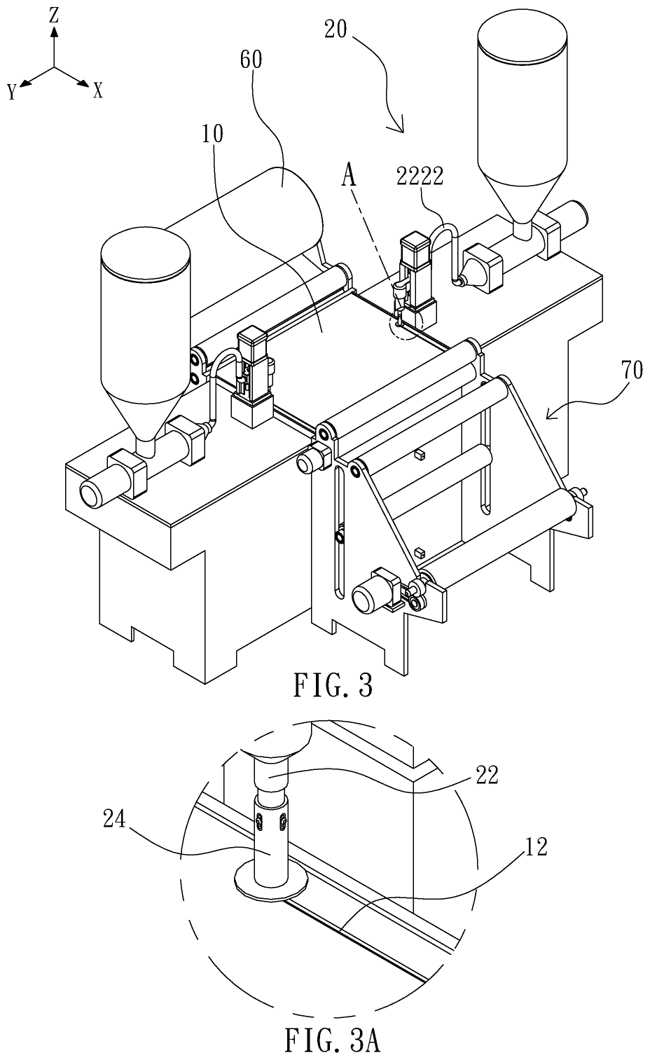

Referring to FIG. 1 through FIG. 4, the present invention provides a plastic woven fabric sewing machine, comprising at least one stitching device 20 at one end of the tabletop of a low-temperature worktable 10. In this embodiment, two stitching devices 20 are provided.

The tabletop of the worktable 10 is provided with at least one thread knot shaping recess 12.

The stitching device 20 includes a stitching needle cylinder 22. The stitching needle cylinder 22 has a cylinder body mounted to a support frame 26 that can be reciprocated up and down. One end of the stitching needle cylinder 22 is formed with a needle portion 221 relative to the thread knot shaping recess 12. The needle portion 221 has a tip that is moved close to and away from the tabletop of the worktable 10 through the cylinder body of the stitching needle cylinder 22 for the tip to be inserted in and out of the thread knot shaping recess 12. The tip is formed with a needle hole 223 communicating with one end of a chamber 222 inside the cylinder body. The other end of the chamber 222 is provided with a material inlet 2221. The material inlet 2221 is configured to receive a pressurized molten plastic material from a material receiving tube 2222. The plastic material may be EVA-ethylene, PP-polypropylene, PE-polyethylene, PVC-polyvinyl chloride, PET-polyethylene terephthalate, HDPE-high-density polyethylene, LDPE-low-density polyethylene, etc.

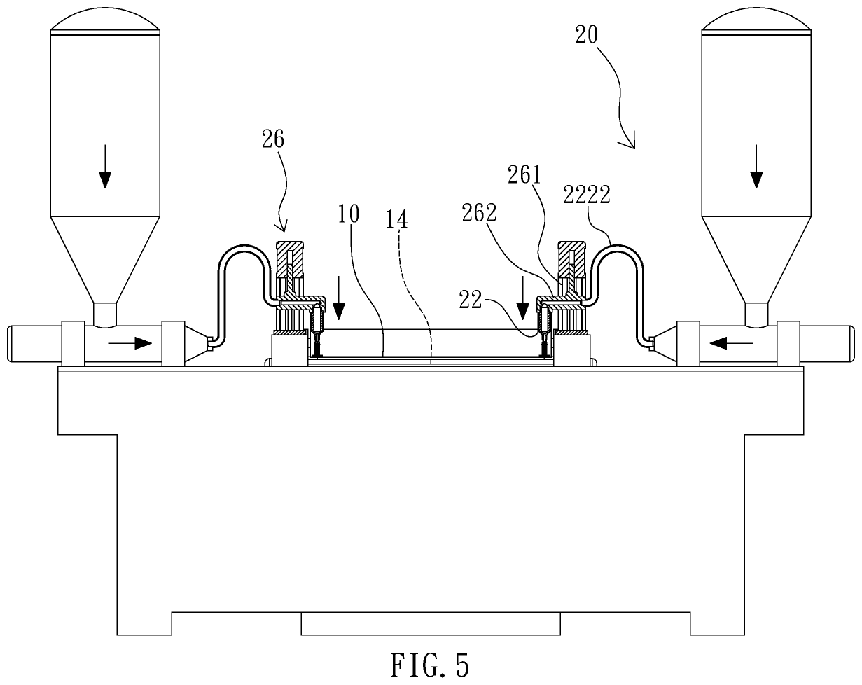

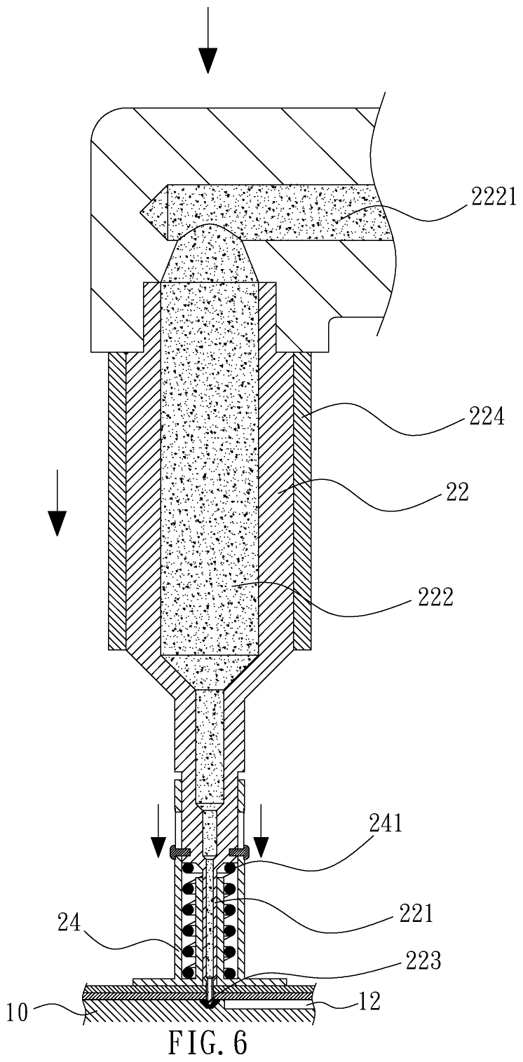

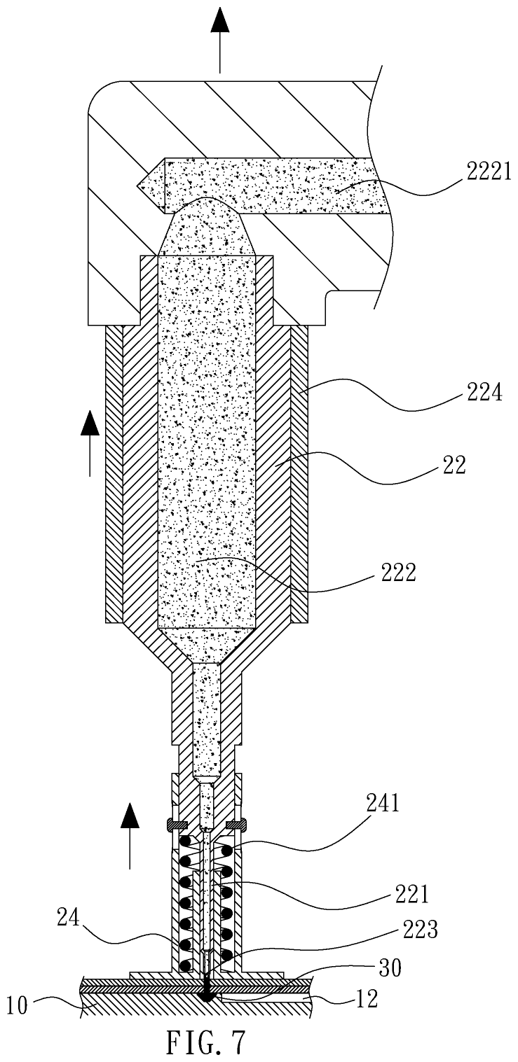

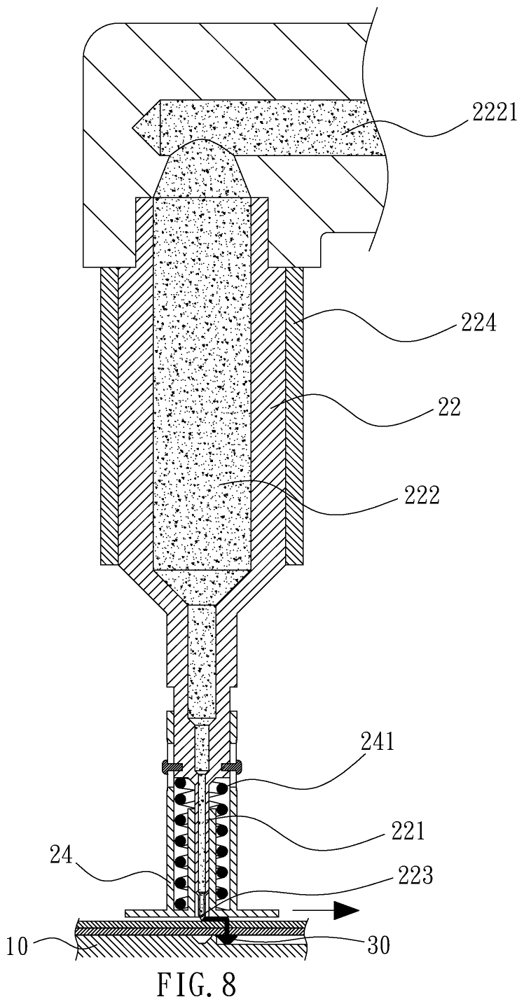

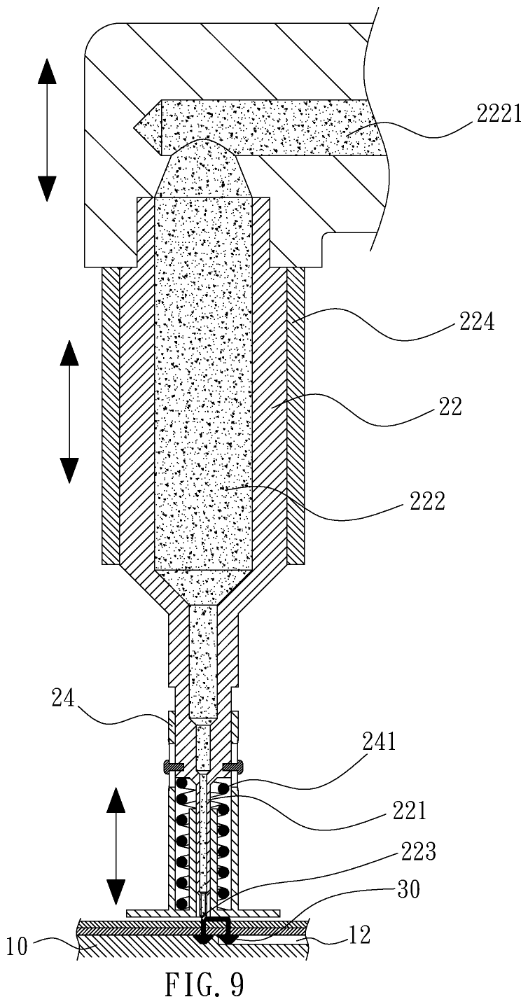

When in use, two overlapped fabrics (made of the same material as the molten plastic material) are placed on the tabletop of the worktable 10 to be stitched (as shown in FIG. 5), and the tip of the needle portion 221 of the stitching needle cylinder 22 penetrates through the two fabrics (as shown in FIG. 6) to enter the thread knot shaping recess 12. The plastic material in the chamber 222 is injected into the thread knot shaping recess 12 from the needle hole 223. After the injected plastic material is cooled (as shown in FIG. 7), it forms a thread knot 30 to buckle the two fabrics. After that, the tip of the needle portion 221 is retracted from the two fabrics (as shown in FIG. 8) to generate a short stitching thread section, and the tip of the needle portion 221 is relatively displaced on the two fabrics (as shown in FIG. 9) to complete one stitch of the two fabrics. The two fabrics can be stitched together by continuous multiple stitches. The stitches each have the thread knot 30 (as shown in FIG. 9) to provide an independent buckle effect, so that the stitches do not affect each other to improve the connection of the two fabrics.

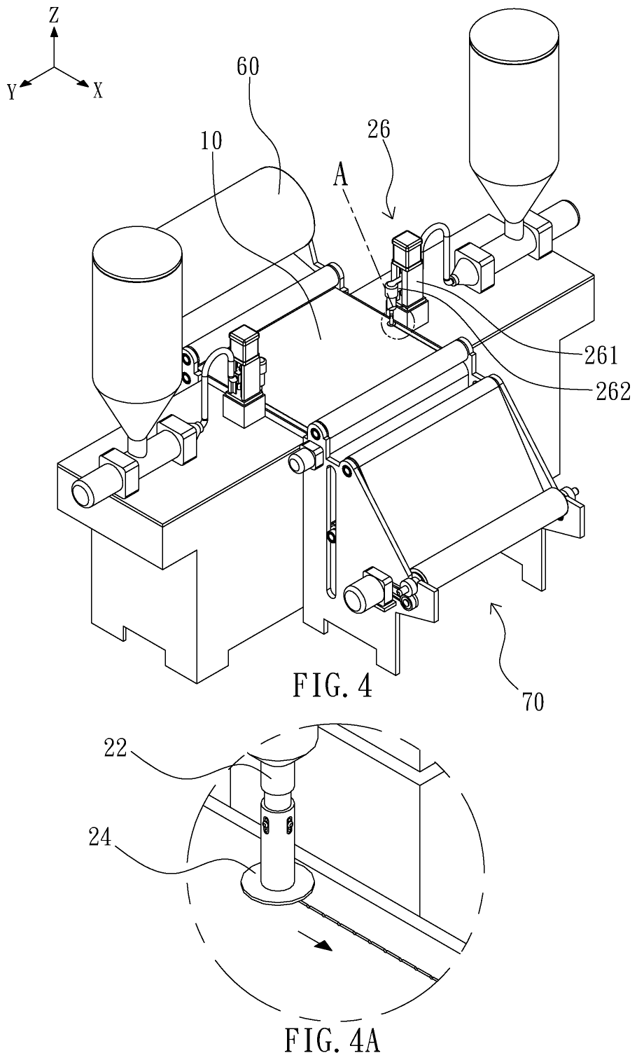

Referring to FIG. 4, FIG. 4A and FIG. 5, the support frame 26 includes a lift platform 261 and a pair of slide seats 262 (using a solenoid valve or pneumatic cylinder as a power source) coupled to the lift platform 261. The stitching needle cylinder 22 is disposed on the slide seats 262. As shown in FIG. 5 and FIG. 6, the slide seats 262 are moved up and down on the lift platform 261 to control the needle portion 221 to perform the stitching action.

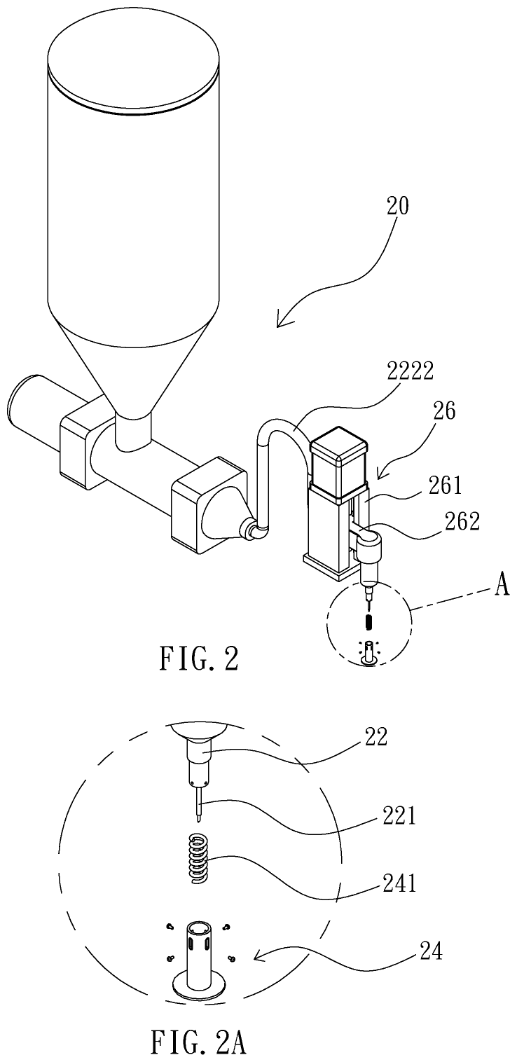

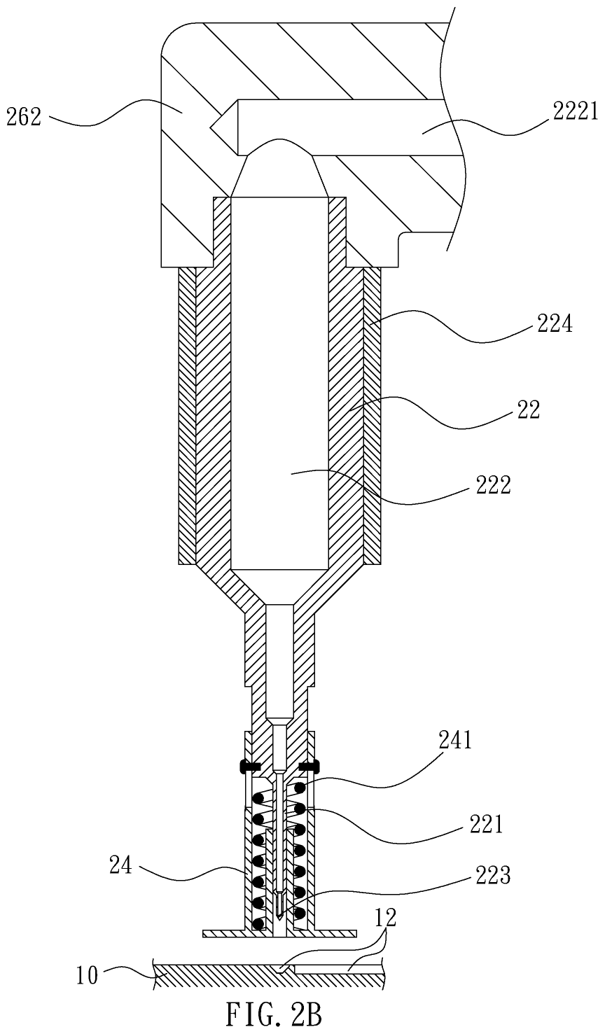

Preferably, referring to FIG. 5 in conjunction with FIG. 2B, the interior of the tabletop is formed with at least one cooling water channel 14 close to the thread knot shaping recess 12. After the plastic material in the chamber 222 is injected from the needle hole 223 into the thread knot shaping recess 12, the cooling water can effectively reduce the temperature of the molten plastic material and accelerate the effect of cooling and solidification.

More preferably, referring to FIGS. 6 to 9 in conjunction with FIG. 2A, a press member 24 is provided around the needle portion 221 of the stitching needle cylinder 22. An elastic member 241 is accommodated between the press member 24 and the end of the stitching needle cylinder 22. When the needle portion 221 of the stitching needle cylinder 22 is inserted downward toward the two fabrics, the end face of the press member 24 is pressed against the two fabrics to stabilize the stitching actions of the needle portion 221. Furthermore, the elastic force of the elastic member 241 returns the press member 24 to the initial position, so as to produce a better stitching smoothness.

Optimally, the stitching needle cylinder 22 has a thermostat 224 (electrically-heated coil, electrically-heated sheet) to maintain the molten state (semi-solidified state) of the plastic material, thereby avoiding solidification of the plastic material in the stitching process.

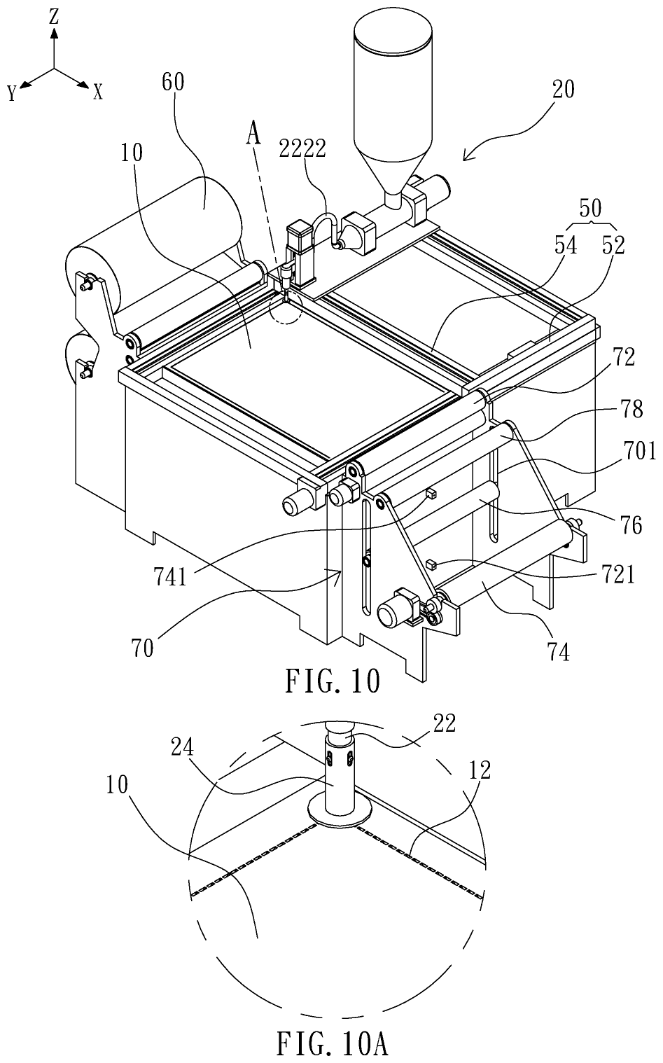

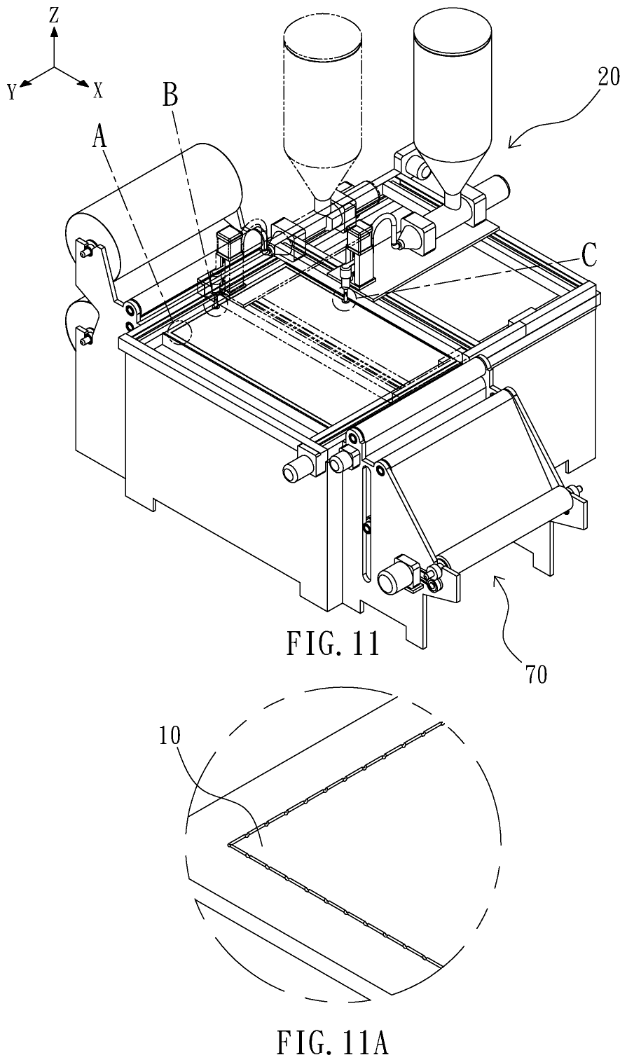

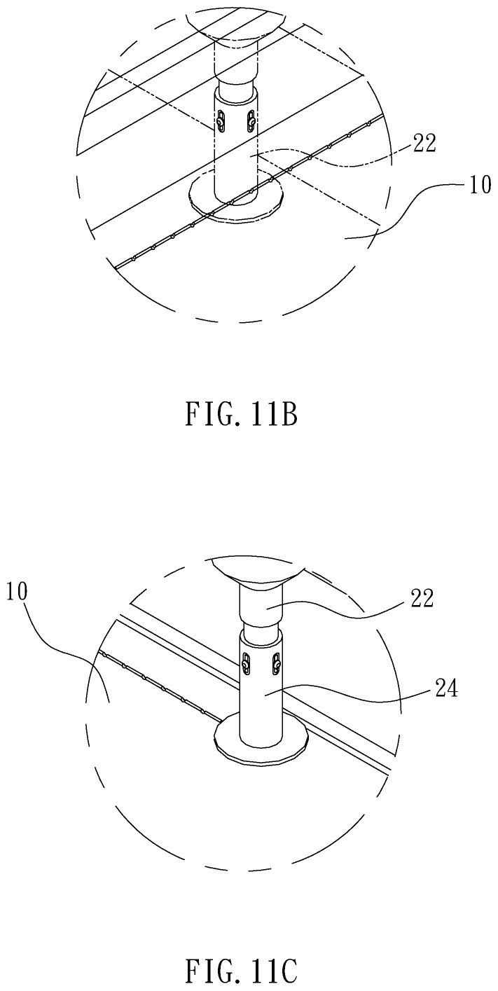

FIG. 10 and FIG. 11, in conjunction with FIG. 2B, illustrate a second implementation of the present invention. The tabletop of the worktable 10 is provided with a linear slide rail assembly 50. (This embodiment includes two linear slide rail assemblies.) The linear slide rail assembly 50 includes a Y-axis linear slide rail 52 and an X-axis linear slide rail 54. The X-axis linear slide rail 54 is configured to slide on the Y-axis linear slide rail 52. The X-axis linear slide rail 54 is provided with the stitching device 20. Through the Y-axis linear slide rail 52 and the X-axis linear slide rail 54, the stitching device 20 performs Y-axis and X-axis displacement and stitching actions on the tabletop, so that the computer automatically controls the stitching effect of the needle portion 221 on the two fabrics.

Preferably, one end of the tabletop of the worktable 10 is provided with a roller feeding device 60, and the other end of the tabletop of the worktable 10 is provided with a roller receiving unit 70. The roller receiving device 70 includes a first receiving roller 72 and a second receiving roller 74. A movable steering roller 76 that is moved up and down in a groove 701 and an immovable steering roller 78 are provided between the first receiving roller 72 and the second receiving roller 74. A first sensor 721 and a second sensor 741 are provided above and under the movable steering cylinder 76, respectively. When the first receiving roller 72 continues to roll up the fabrics, the movable steering roller 76 is displaced to the bottom of the groove 701 to trigger the first sensor 721, such that the first receiving roller 72 stops and the second receiving roller 74 starts to roll up the fabrics. When the second receiving roller 74 continues to roll up the fabrics, the movable steering roller 76 is displaced to the top of the groove 701 to trigger the second sensor 741, such that the second receiving roller 74 stops and the first receiving roller 72 starts to roll up the fabrics. The roller receiving unit 70 can precisely roll up the fabrics.

Finally, referring to FIG. 10 and FIG. 11 in conjunction with FIG. 5, the material receiving tube 2222 is a soft curved tube, so as to prevent the tube from rupturing in the lifting and lowering process of the stitching needle cylinder 22 and to improve the durability of use.

Although particular embodiments of the present invention have been described in detail for purposes of illustration, various modifications and enhancements may be made without departing from the spirit and scope of the present invention. Accordingly, the present invention is not to be limited except as by the appended claims.

1. A plastic woven fabric sewing machine, comprising at least one stitching device at one end of a tabletop of a low-temperature worktable;
the tabletop of the worktable being provided with at least one thread knot shaping recess;
the stitching device including a stitching needle cylinder, the stitching needle cylinder having a cylinder body mounted to a support frame that can be reciprocated up and down, one end of the stitching needle cylinder being formed with a needle portion relative to the thread knot shaping recess, the needle portion having a tip that is moved close to and away from the tabletop of the worktable through the cylinder body of the stitching needle cylinder for the tip to be inserted in and out of the thread knot shaping recess, the tip being formed with a needle hole communicating with one end of a chamber inside the cylinder body, another end of the chamber being provided with a material inlet, the material inlet being configured to receive a pressurized molten plastic material from a material receiving tube;
wherein when in use, two overlapped fabrics are placed on the tabletop of the worktable to be stitched, the tip of the needle portion of the stitching needle cylinder penetrates through the two fabrics to enter the thread knot shaping recess, the plastic material in the chamber is injected into the thread knot shaping recess from the needle hole, after the injected plastic material is cooled, it forms a thread knot to buckle the two fabrics, after that, the tip of the needle portion is retracted from the two fabrics to generate a short stitching thread section, the tip of the needle portion is relatively displaced on the two fabrics to complete one stitch of the two fabrics, the two fabrics are stitched together through continuous multiple stitches, and the stitches each have the thread knot to provide an independent buckle effect so that the stitches do not affect each other.

2. The plastic woven fabric sewing machine as claimed in claim 1, wherein the support frame includes a lift platform and a pair of slide seats, and the stitching needle cylinder is disposed on the slide seats.

3. The plastic woven fabric sewing machine as claimed in claim 2, wherein the slide seats include a solenoid valve or pneumatic cylinder as a power source to move up and down on the lift platform.

4. The plastic woven fabric sewing machine as claimed in claim 2, wherein the slide seats include a solenoid valve or pneumatic cylinder as a power source to move up and down on the lift platform.

5. The plastic woven fabric sewing machine as claimed in claim 4, wherein the linear slide rail assembly includes a Y-axis linear slide rail and an X-axis linear slide rail, the X-axis linear slide rail is configured to slide on the Y-axis linear slide rail, and the X-axis linear slide rail is provided with the stitching device.

6-10. (canceled)

11. The plastic woven fabric sewing machine as claimed in claim 1, wherein one end of the tabletop of the worktable is provided with a roller feeding device, and another end of the tabletop of the worktable is provided with a roller receiving unit.

12. The plastic woven fabric sewing machine as claimed in claim 11, wherein the roller receiving device includes a first receiving roller and a second receiving roller, a movable steering roller that is moved up and down in a groove and an immovable steering roller are provided between the first receiving roller and the second receiving roller, a first sensor and a second sensor are provided above and under the movable steering cylinder, respectively.

13. The plastic woven fabric sewing machine as claimed in claim 1, wherein an interior of the worktable is provided with at least one cooling water channel close to the thread knot shaping recess.

14. The plastic woven fabric sewing machine as claimed in claim 1, wherein a press member is provided around the needle portion of the stitching needle cylinder, and an elastic member is accommodated between the press member and the end of the stitching needle cylinder.

15. The plastic woven fabric sewing machine as claimed in claim 1, wherein the stitching needle cylinder has a thermostat for maintaining a molten state of the plastic material.
